(19) United States
(12) Patent Application Publication
(10) Pub. No.: US 2023/0072108 A1
(43) Pub. Date: Mar. 9, 2023

(54) METHOD AND SYSTEM FOR HOUSING AN IMAGE

(71) Applicant: VERASEAL PTY LTD., Sydney NSW (AU)

(72) Inventor: Mark Donald Goodall, Vaucluse (AU)

(73) Assignee: VERASEAL PTY LTD., Sydney NSW (AU)

(21) Appl. No.: 17/471,097

(22) Filed: Sep. 9, 2021

(51) Int. Cl. A47G 1/06; A47G 1/16

(52) U.S. Cl. CPC A47G 1/0638; A47G 1/162

(57) ABSTRACT

A housing for an image can be formed from a sheet of malleable material, such as PETG. The sheet can comprise cutouts spaced about a perimeter of the sheet. Channels formed in a surface of the sheet can extend between adjacent cutouts. The image can be printed on the surface and can extend into the channels. With the sheet at ambient temperature, the sheet can be bent at the channels to form corners extending along the channels. The channels can comprise geometries that support printing in the channels, forming corners having specified angles, and image presentation at the formed corners. The sheet can comprise apertures that align when the sheet is bent. A member composed of elastomeric material can be inserted through the aligned apertures to hold the alignment. The member can comprise a projection that projects from the apertures behind the housing and that comprises a bumper.

### TECHNICAL FIELD

Embodiments of the technology relate generally to images and more particularly to methods and systems for housing and presentation of images.

### BACKGROUND

Need exists for improved capabilities relating to housing and presenting images and three-dimensional objects. For instance, need exists for improved capabilities relating to forming a housing for an image from a sheet of material via cold working or processing at ambient temperature. Need exists for improved capabilities in connection with forming a housing for an image readily and according to predetermined geometrical features. Need exists for improved capabilities in connection with presenting an image that is disposed in a housing with the image extending across a corner of the housing. Need exists for improved capabilities in connection with securing structurally a housing for an image. Need exists for improved capabilities in connection with bumpering a housing for an image. Technology addressing one or more such needs, or some related deficiency in the art, would benefit the field of housing and presenting images and three-dimensional objects.

### SUMMARY

A housing can support housing, enclosing, protecting, mounting, presenting, and/or displaying one or more images or one or more three-dimensional objects. Such an object can comprise a commercial product, a mechanism or machine, or an archeological artifact, to name a few representative examples without limitation.

In one aspect of the disclosure, a sheet of clear thermoplastic material can be cold worked to provide a housing for one or more images or three-dimensional objects. The sheet can, for example, be worked at ambient temperature. The sheet of material can have a perimeter or outline defining a geometrical form, for example a rectangle, a hexagon, a triangle, or a polygon. One or more strip-shaped areas of the material extending along at least a portion of the perimeter can be bent to form one or more corners that are disposed between the strip-shaped area(s) and a central area of the sheet and that extend lengthwise. The corner may be sharp or rounded and may provide a perpendicular angle or an angle that is acute or obtuse. The bent strip and the central portion of the sheet can define an interior space that is at least partially enclosed. An interior surface of the formed sheet can serve as a substrate for an image, and/or features or elements can be attached to or embedded in the sheet. In some examples, one or more images or objects can be disposed in the space. In some examples, the sheet comprises polyethylene terephthalate glycol (PETG).

In a further aspect of the disclosure, a channel can be provided on a surface of a sheet of clear thermoplastic material that provides a substrate for an image. An image to be applied to the sheet can comprise three image portions. A first portion of the image can be applied to the sheet on a first side of the channel. A second portion of the image can be applied to the sheet within the channel. A third portion of the image can be applied to the sheet on a second side of the channel, opposite the first side. With the first, second, and third portions of the image so applied, the image can extend contiguously across the channel. The sheet can be formed to provide a corner extending lengthwise along the channel. The forming can transform the sheet from a planar geometry to a three-dimensional geometry in which an angle with a vertex is formed at the channel. The image can extend across the corner. The channel can have a geometry that supports printing the image in the channel, forming the corner to a specified angle, and image presentation at the formed corner.

In a further aspect of the disclosure, a housing for an image can comprise at least one front pane, four side panes that extend from the front pane, and four rear panes that extend from the side panes. Adjacent rear panes can comprise overlapping portions, for instance edges or flaps that overlap. The overlapping portions of adjacent rear panes can comprise pairs of apertures that align. Members can be inserted into each pair of aligned apertures to maintain aperture alignment and thereby secure the housing structurally in a three-dimensional form of desired geometry. Elastic properties of the member can facilitate insertion of the members and can further help hold the members in place. The members can be composed of an elastomer or an elastomeric material, for example silicone or synthetic rubber. The members can comprise pins with heads that project rearward from the housing. The heads of the pins can protect the housing from impact by absorbing shock, for example associated with positioning a rear of the housing against a hard surface, such as a wall against which the housing is to be mounted or a table upon which the housing is placed. Each member can comprise a bumper and a fastener.

The foregoing discussion about housing images and objects for presentation is for illustrative purposes only. Various aspects of the present disclosure may be more clearly understood and appreciated from a review of the following text and by reference to the associated drawings and the claims that follow. Other aspects, systems, methods, features, advantages, and objects of the present disclosure will become apparent to those with skill in the art upon examination of the following drawings and text. It is intended that all such aspects, systems, methods, features, advantages, and objects are to be included within this description and covered by this paper and by the appended claims.

### BRIEF DESCRIPTION OF THE FIGURES

FIGS. 1A and 1B, collectively FIG. 1, are perspective illustrations of a housing with a housed image, in which FIG. 1B is a detailed perspective view of a corner, in accordance with some example embodiments of the disclosure.

FIGS. 2A and 2B, collectively FIG. 2, are perspective illustrations of a housing with a housed image, in which FIG. 2B is a detailed perspective view of a corner, in accordance with some example embodiments of the disclosure.

FIGS. 3A and 3B, collectively FIG. 3, are perspective illustrations of a housing with a housed image, in which FIG. 3B is a detailed perspective view of a corner, in accordance with some example embodiments of the disclosure.

FIG. 4 is an illustration of a blank in accordance with some example embodiments of the disclosure.

FIGS. 5A, 5B, and 5C, collectively FIG. 5, are cross-sectional illustrations of the blank at Section A-A in two channel embodiments in accordance with some example embodiments of the disclosure.

FIGS. 6A and 6B, collectively FIG. 6, are cross-sectional illustrations of bit for cutting a channel in the blank and the bit cutting the channel in accordance with some example embodiments of the disclosure.

FIG. 7 is a cross-sectional illustration of the blank at Section B-B that is printed with an image in accordance with some example embodiments of the disclosure.

FIG. 8 is a cross-sectional illustration of forming corners in the blank and printed image in accordance with some example embodiments of the disclosure.

FIG. 9 is a cross-sectional illustration of formed corners in the blank and printed image in accordance with some example embodiments of the disclosure.

FIG. 10 is a detail cross-sectional illustration of a formed corner in the blank and printed image in accordance with some example embodiments of the disclosure.

FIGS. 11A, 11B, 11C, 11D, and 11E collectively FIG. 11, are four illustrations of progressively forming the blank and printed image into a three-dimensional housing that houses the printed image and one detail illustration in accordance with some example embodiments of the disclosure.

FIGS. 12A, 12B, 12C, 12D, 12E, and 12F, collectively FIG. 12, are illustrations of securing a housing in a three-dimensional structure using hybrid fastener-bumper members in accordance with some example embodiments of the disclosure.

FIG. 13 is an illustration of a flow chart of a process for housing an image in accordance with some example embodiments of the disclosure.

Many aspects of the disclosure can be better understood with reference to these figures. The elements and features shown in the Figures are not necessarily to scale, emphasis being placed upon clearly illustrating principles of example embodiments of the disclosure. Moreover, certain dimensions may be exaggerated to help visually convey such principles. In the Figures, reference numerals often designate like or corresponding, but not necessarily identical, elements throughout the several views.

### DETAILED DESCRIPTION OF EXAMPLE EMBODIMENTS

The technology will be discussed more fully hereinafter with reference to the Figures, which provide additional information regarding representative or illustrative embodiments of the disclosure. The present technology can be embodied in many different forms and should not be construed as limited to the embodiments set forth herein; rather, these embodiments are provided so that this disclosure will be thorough and complete, and will fully convey the scope of the technology to those having ordinary skill in the art. Furthermore, all “examples,” “embodiments,” and “exemplary embodiments” provided herein are intended to be non-limiting and among others supported by representations of the disclosure.

Those of ordinary skill in the art having benefit of this disclosure will be able, without undue experimentation, to combine compatible elements and features that are described at various places in this written description, which includes text and illustrations. That is, the illustrations and specification are organized to facilitate practicing numerous combinations, such as by combining an element of one illustrated embodiment with another element of another illustrated embodiment or by combining a feature disclosed in an early paragraph of the specification with another element disclosed in a later paragraph of the specification.

This document includes sentences, paragraphs, and passages (some of which might be viewed as lists) disclosing alternative components, elements, features, functionalities, usages, operations, steps, etc. for various embodiments of the disclosure. Unless clearly stated otherwise, all such lists, sentences, paragraphs, passages, and other text are not exhaustive, are not limiting, are provided in the context of describing representative examples and variations, and are among others supported by various embodiments of the disclosure. Accordingly, those of ordinary skill in the art having benefit of this disclosure will appreciate that the disclosure is not constrained by any such lists, examples, or alternatives. Moreover, the inclusion of lists, examples, embodiments, and the like (where provided as deemed beneficial to the reader) may help guide those of ordinary skill in practicing many more implementations and instances that embody the technology without undue experimentation, all of which are intended to be within the scope of the claims.

This disclosure includes figures and discussion in which features and elements of certain embodiments may be organized into what might be characterized as functional units, blocks, subsystems, or modules. And, certain processes and methods may be organized into blocks or into steps. Such organization is intended to enhance readership and to facilitate teaching the reader about working principles of the technology and about making and using an abundance of embodiments of the disclosure. The organization is not intended to force any rigid divisions or partitions that would limit the disclosure. In practice, the flexibility of the technology and the depth of this disclosure supports dispersing or grouping functionalities, elements, and features in many different ways. The inclusion of an element or function in one block, unit, module, or subsystem verses another may be substantially arbitrary in many instances, with the divisions being soft and readily redrawn using ordinary skill in combination with the teaching provided herein. Accordingly, functional blocks, modules, subsystems, units, and the like can be combined, divided, repartitioned, redrawn, moved, reorganized, or otherwise altered without deviating from the scope and spirit of the disclosure. This is not to say that, nor will it support a conclusion that, any disclosed organizations and combinations are not novel, are not innovative, or are obvious.

Certain steps in the processes and methods disclosed or taught herein, may naturally need to precede others to achieve desirable functionality. However, the disclosure is not limited to the order of the described steps if such order or sequence does not adversely alter functionality to the extent of rendering the technology inoperable or nonsensical. That is, it is recognized that some steps of a process or method may be performed before or after other steps or in parallel with other steps without departing from the scope and spirit of the disclosure.

In some instances, a process or method (for example that entails using, making, or practicing) may be discussed with reference to a particular illustrated embodiment, application, or environment. For example, a flowchart may reference or be discussed with reference to a figure. Those of skill in the art will appreciate that any such references are by example and are provided without limitation. Accordingly, the disclosed processes and methods can be practiced with other appropriate embodiments supported by the present disclosure and in other appropriate applications and environments. Moreover, one of ordinary skill in the art having benefit of this disclosure will be able to practice many variations of the disclosed and flowcharted methods and processes as may be appropriate for various applications and embodiments.

The term “fasten,” as used herein, generally refers to physically coupling something to something else firmly or securely.

The term “fastener,” as may be used herein, generally refers to an apparatus or system that fastens something to something else, whether releasably, temporarily, or permanently.

The term “connector,” as used herein, generally refers to an apparatus or system that connects something with something else.

The term “couple,” as may be used herein, generally refers to joining, connecting, or associating something with something else.

As one of ordinary skill in the art will appreciate, the term “operably coupled,” as may be used herein, encompasses direct coupling and indirect coupling via another, intervening component, element, or module; moreover, a first component may be operably coupled to a second component when the first component comprises the second component.

As one of ordinary skill in the art will appreciate, each of the terms “approximate” and “approximately,” as may be used herein, provides an industry-accepted tolerance for the corresponding term it modifies. Similarly, the terms “substantial” and “substantially,” as may be used herein, provide an industry-accepted tolerance for the corresponding term modified. Such industry-accepted tolerances range from less than one percent to twenty percent and correspond to, but are not limited to, component values, process variations, and manufacturing tolerance.

As appreciated by those of skill in the art, unless clearly specified otherwise, the values provided herein are intended to reflect commercial design practices or nominal manufacturing targets. For example, what may be described or specified as a 90-degree angle, may deviate from 90 degrees when implemented in a commercial product due to fabrication error, warpage, or customary tolerances.

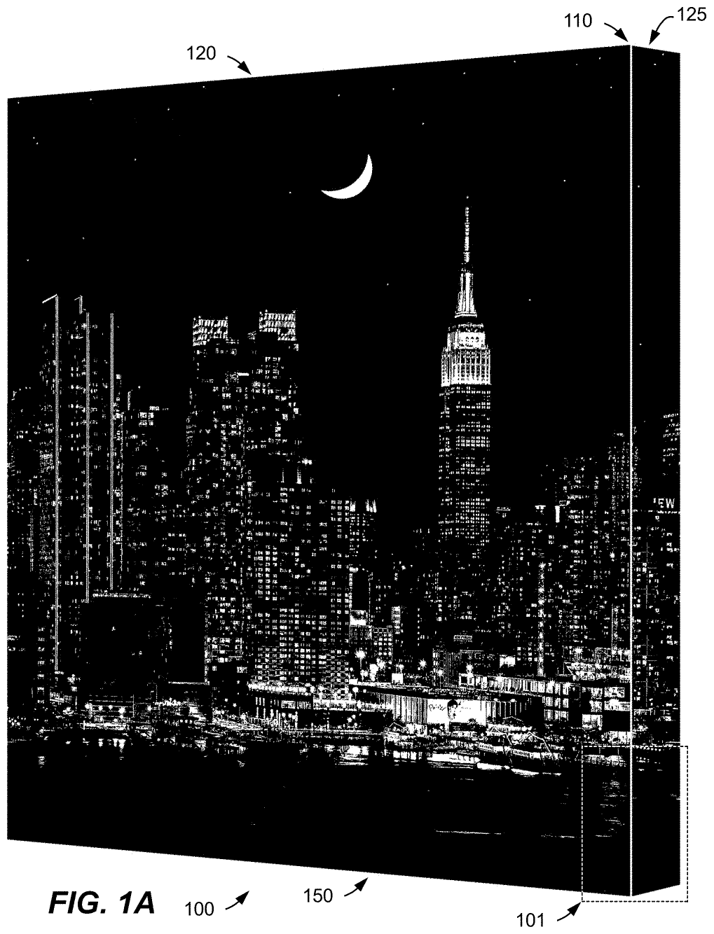

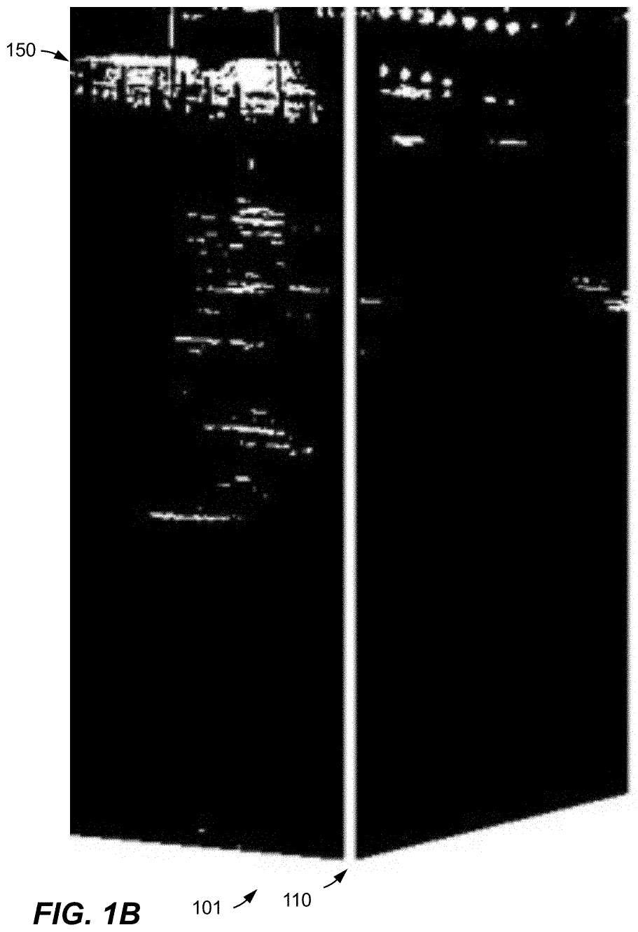

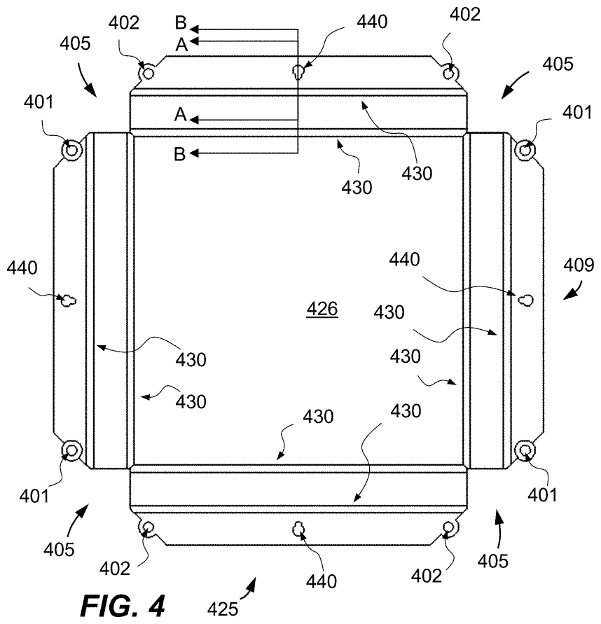

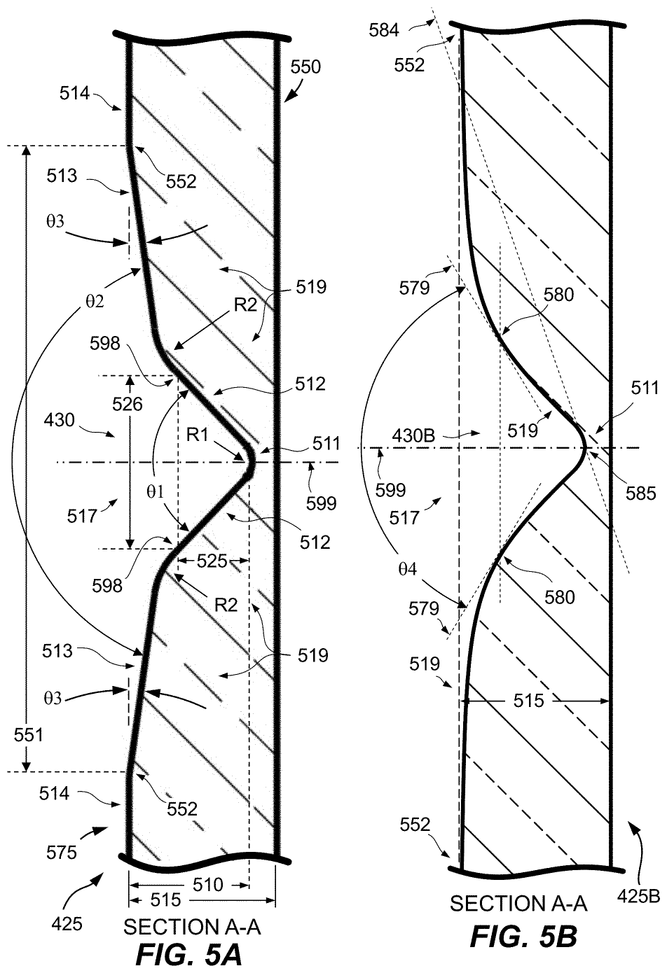

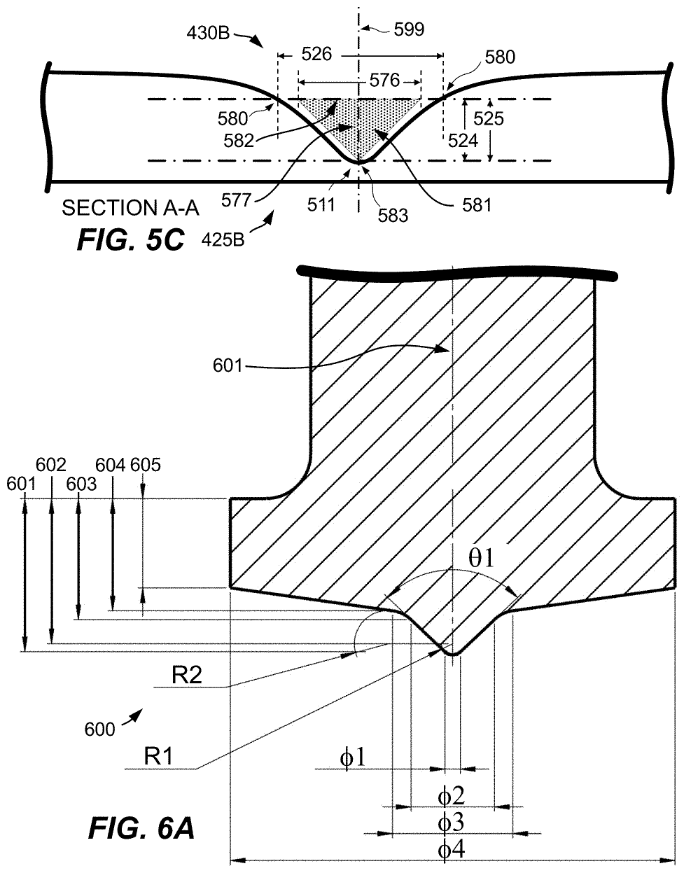

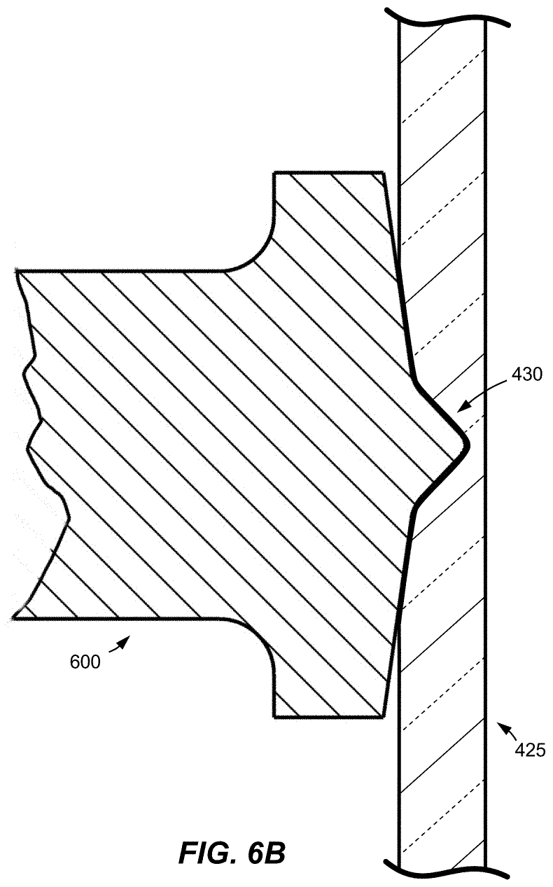

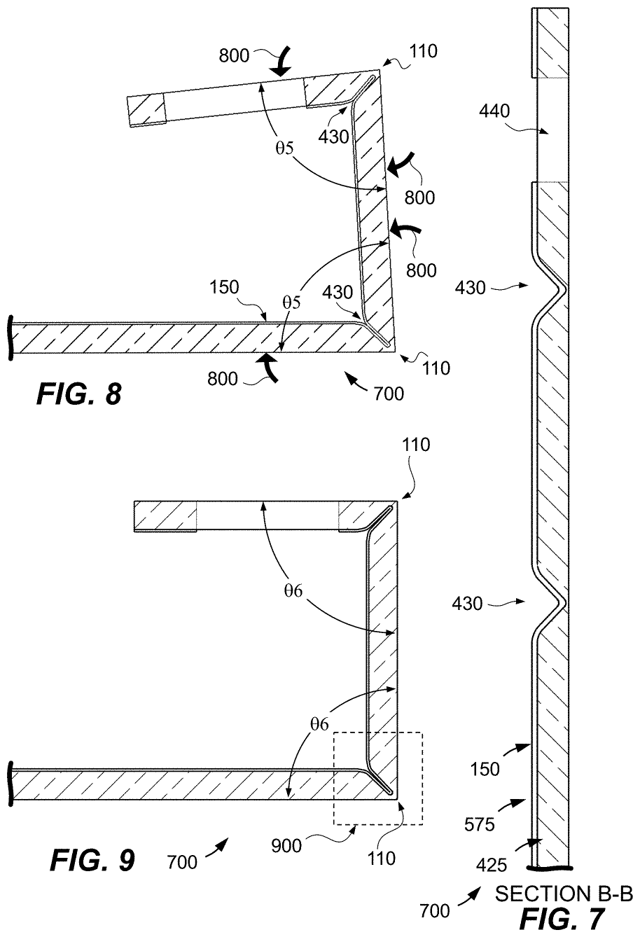

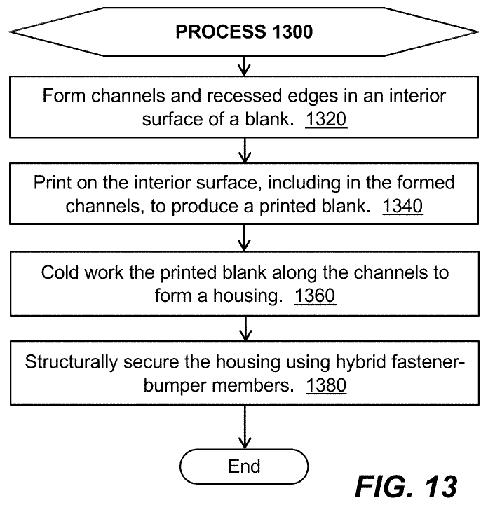

Referring now to the Figures, FIGS. 1, 2, and 3 describe three housings 100, 101, 102 that house an image 150. FIGS. 4 and 5 describe representative features of a blank 425 from which the housing 100 of FIG. 1 can be formed. FIGS. 6 and 7 describe representative features of forming the blank 425 from a malleable sheet of clear thermoplastic material and printing the image 150 on the blank 425 to produce a printed blank 700. FIGS. 8, 9, 10, 11, and 12 describe representative features of forming the housing 100 of FIG. 1 from the printed blank 700. FIG. 13 describes a representative fabrication process 1300. The figures will now be further discussed in turn.

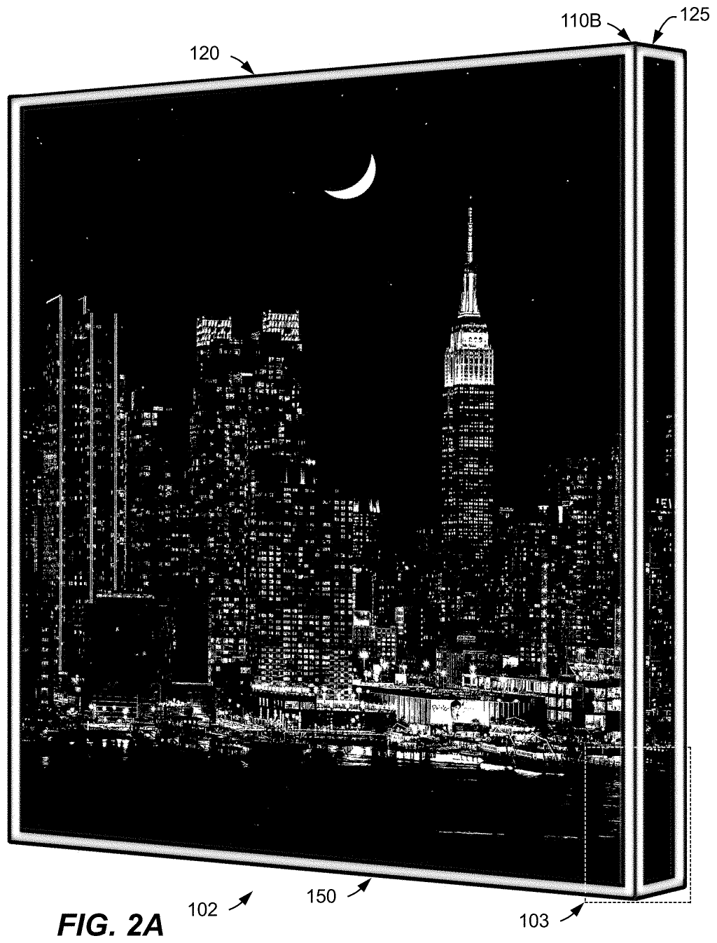

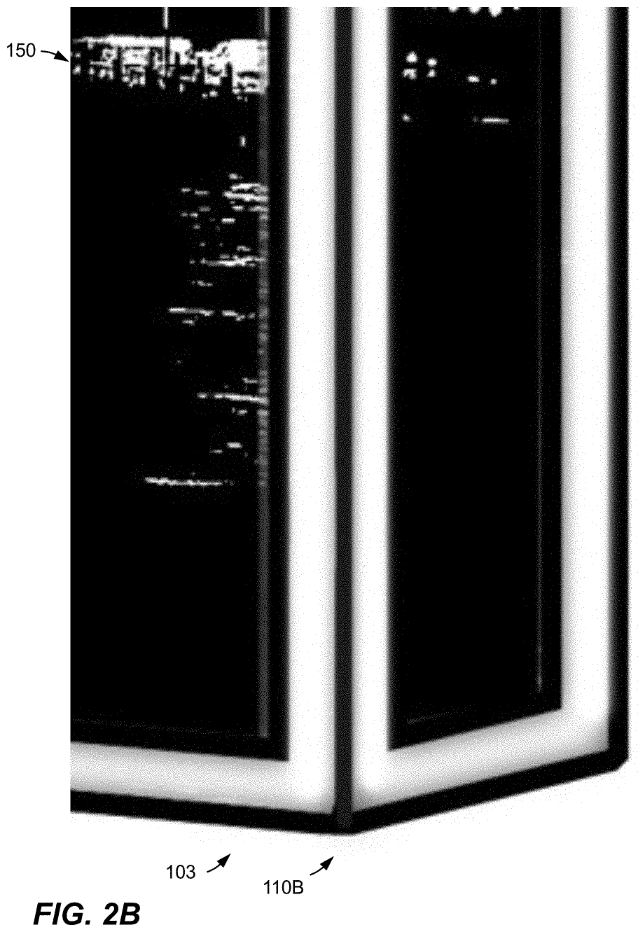

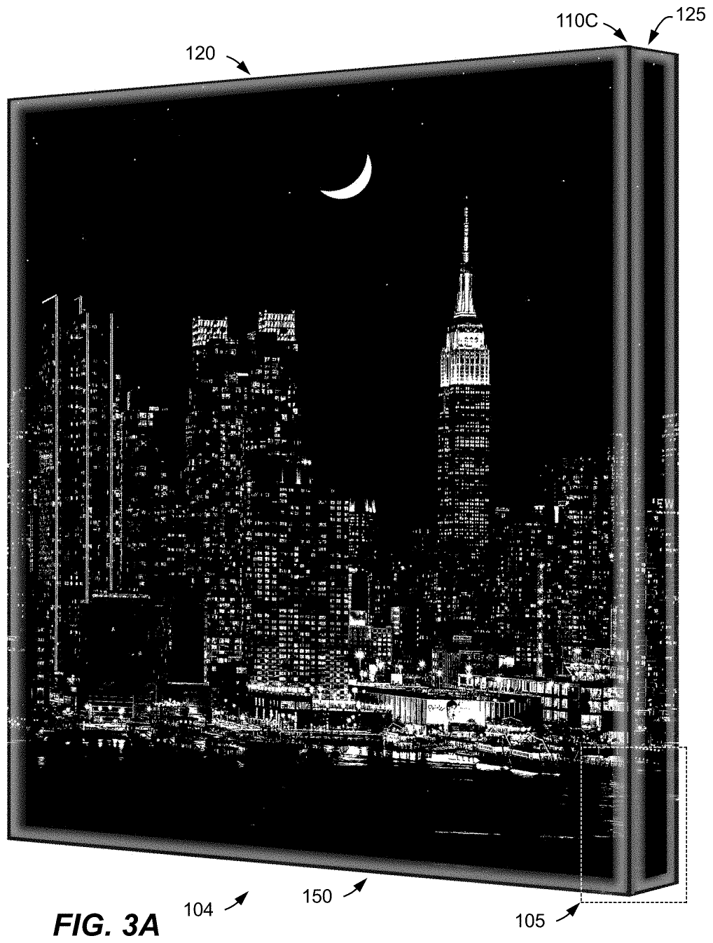

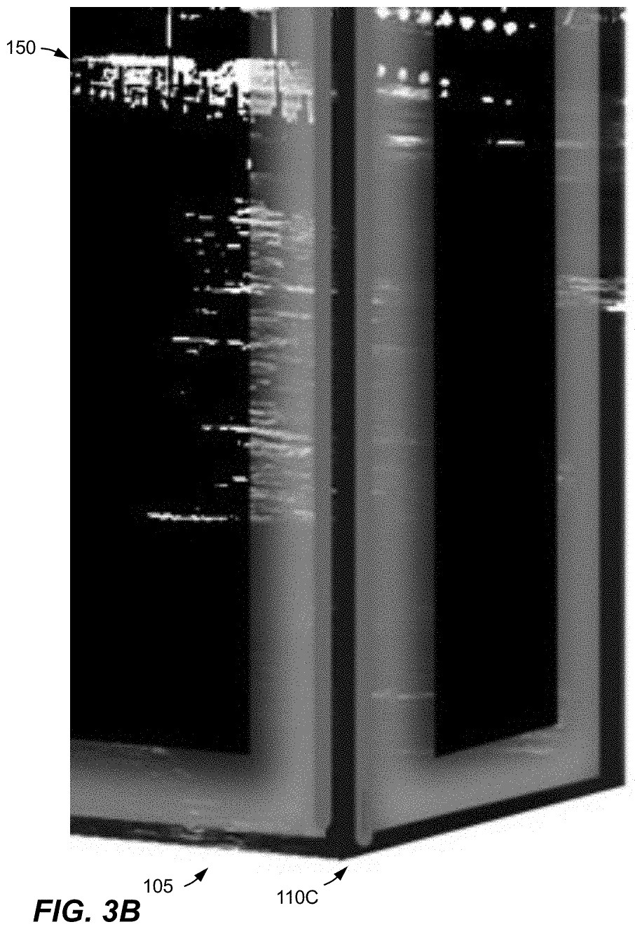

Turning now to FIGS. 1, 2, and 3, these figures will be discussed. FIGS. 1, 2, and 3 respectively illustrate three housing 100, 102, 104 for the same nightscape image 150 in perspective view. FIGS. 1A and 1B illustrate the example housing 100 housing the nightscape image 150, with FIG. 1B illustrating a detailed view of a portion 101 of the housing 100 comprising an example corner 110, according to some embodiments of the disclosure. FIGS. 2A and 2B illustrate the example housing 102 housing the nightscape image 150, with FIG. 2B illustrating a detailed view of a portion 103 of the housing 102 comprising an example corner 110B, according to some embodiments of the disclosure. FIGS. 3A and 3B illustrate the example housing 104 housing the nightscape image 150, with FIG. 3B illustrating a detailed view of a portion 105 of the housing 104 comprising an example corner 110C, according to some embodiments of the disclosure.

Each of the illustrated housings 100, 102, 104 comprises a front pane 120 and four side panes 125 extending rearward from a perimeter of the front pane 120. The respective front panes 120 and side panes 125 meet to form the corners 110, 110B, 110C. The corner 110 visible and labeled in FIG. 1A is one of four front corners of the housing 100. The corner 110B visible and labeled in FIG. 2A is one of four front corners of the housing 102. The corner 100C visible and labeled in FIG. 3A is one of four front corners of the housing 103. As further discussed below, the corner 110, the corner 110B, and the corner 110C) are implemented utilizing three distinct configurations, resulting in three distinct effects on the nightscape image 150. FIGS. 1, 2, and 3 were generated by manually manipulating the nightscape image 150 at each corner 110, 110B, 110C based on experimental tests that were conducted. In the experimental testing, three housings were fabricated utilizing three distinct channel/printing approaches to produce three distinct corners, and effects on housed images at the three corners were observed. FIGS. 1, 2, and 3 generally describe the observed effects, respectively. To produce FIGS. 1, 2, and 3, the nightscape image 150 was stored digitally in a computer. Image-manipulation software was used to change the digitally stored nightscape image 150 manually based on experimental observations. Thus, FIGS. 1, 2, and 3 are not actual experimental data; rather, FIGS. 1, 2, and 3 generally reflect experimental observations as applied to the nightscape image 150. Based on the experimental observations, images with dark backgrounds and bright foregrounds (such as a nightscape) seem to accentuate distinctions between the three channel configurations, possibly associated with heightened contrast. Accordingly, FIGS. 1, 2, and 3 may be viewed as an exaggerated comparison.

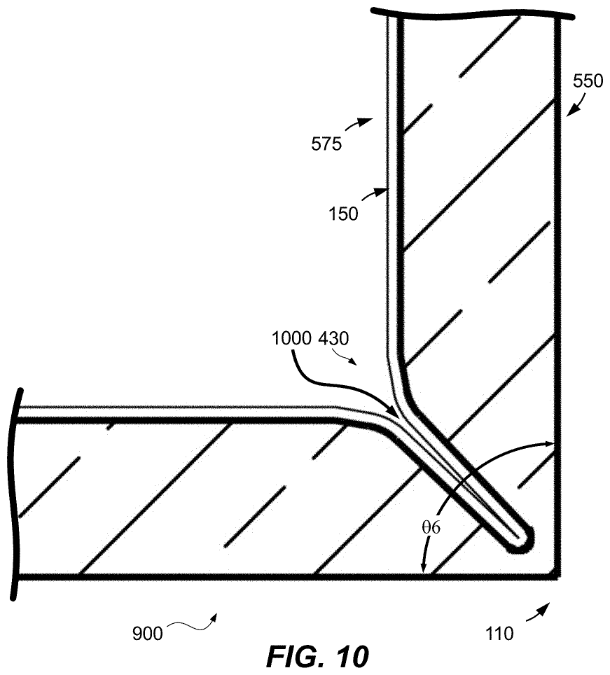

The housing 100 of FIG. 1 comprises a channel (see reference number 430 in FIG. 5A) that extends along the corner 110 on an interior surface of the housing 100 as illustrated by FIGS. 4, 5, 6, 7, 8, 9, 10, and 11 and as discussed below with reference to FIGS. 4, 5, 6, 7, 8, 9, 10, and 11. The channel 430 comprises geometric features consistent with FIG. 5A, and the nightscape image 150 is printed across and in the channel 430 as illustrated by FIGS. 7 and 10.

The housing 102 of FIG. 2 comprises like channel geometry to the housing 100 of FIG. 1, but with different image printing. Thus, the housing 100 and the housing 102 utilize consistent channel geometry and different image printing. In the housing 102 of FIG. 2, the nightscape image 150 is printed on opposing lateral sides of the channel 430, but without printing in the channel 430. Thus for the housing 102 of FIG. 2, the channel 430 is void of image printing.

The housing 104 of FIG. 3 comprises a distinct channel geometry. The channel of the housing 104 lacks a mouth 517 that is widened as illustrated in FIG. 5A. That is, for the channel of the housing 103, the channel 430 that FIG. 5A illustrates is modified, so that the inner surfaces 512 of the sidewalls 511 of the channel 430 extend at the illustrated included angle θ1 from the bottom 511 of the channel 430 to the channel rims at the interior surface 575. In the housing 104, the nightscape image 150 is printed across and in the channel 430 consistent with the image printing of the housing 100 of FIG. 1.

While image presentation across the corner 110 of FIG. 1 exhibits enhanced fidelity relative to image presentation across the corner 110B of FIG. 2 and across the corner 110C of FIG. 3, the foregoing comparisons do not constitute disclaimer or disparagement of any aspects of the embodiments of FIGS. 2 and 3. Although the enhanced fidelity offered by the embodiment of FIG. 1 is beneficial in many applications, the image effects that FIGS. 2 and 3 illustrate can be desirable in certain applications, for instance forming a vignette that serves to emphasize or highlight certain aspects of an image. For example, the vignette can facilitate education of students who have been instructed to view the image as part of a lesson in science or history, by the vignette emphasizing an aspect of the image that is particularly relevant to the lesson. FIGS. 4, 5, 6, 7, 8, 9, 10, 11, 12, and 13 will be largely discussed below with example reference, and without limitation, to the housing 150 that FIG. 1 illustrates.

Turning now to FIG. 4, this figure illustrates an example blank 425 according to some embodiments of the disclosure. As illustrated, the blank 425 comprises a sheet of clear plastic material that is malleable. In some example embodiments, the plastic material comprises a thermoplastic material. In the illustrated example embodiment of FIG. 4, the blank 425 comprises a sheet of clear PETG. As further discussed below with reference to FIGS. 5, 6, 7, 8, 9, 10, 11, 12, and 13, the example housing 100 that FIG. 1 illustrates can be formed from the blank 425. Thus, the blank 425 can be transformed from the sheet geometry that FIG. 4 illustrates into the three-dimensional geometry that FIG. 1 illustrates.

In some example embodiments, as a alternative to PETG, the blank 425 can comprise polymethyl methacrylate (PMMA) (acrylic), polycarbonate, or other appropriate rigid plastic material. As will be appreciated by those of skill in the art, the plastics industry uses “rigid plastic” to refer to a recognized category of plastics, which includes PETG, PMMA, and polycarbonate. In some example embodiments, the blank 425 comprises an additive that absorbs ultraviolet (UV) light to protect images 150 from UV degradation.

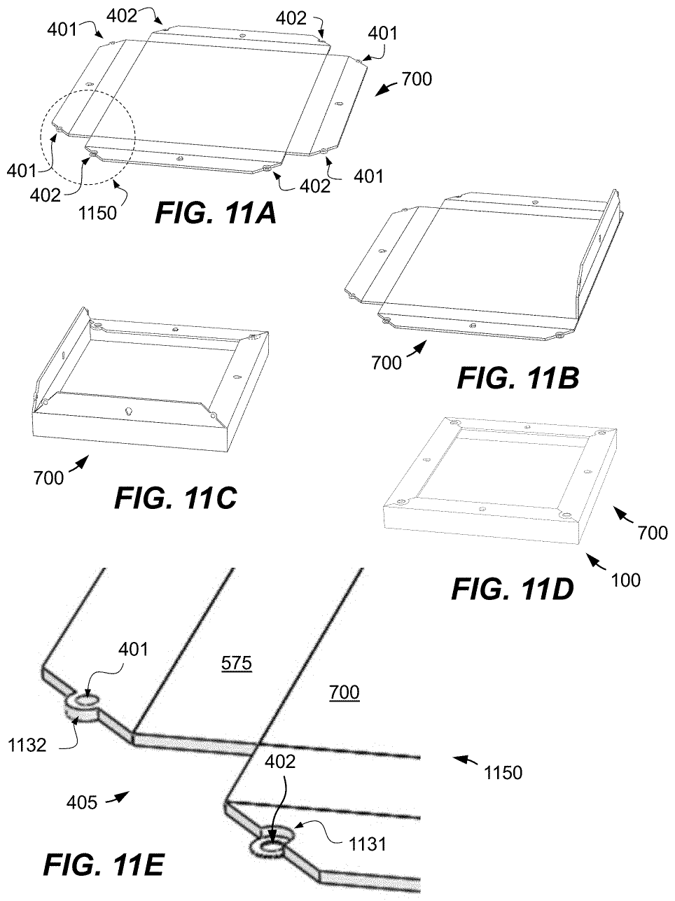

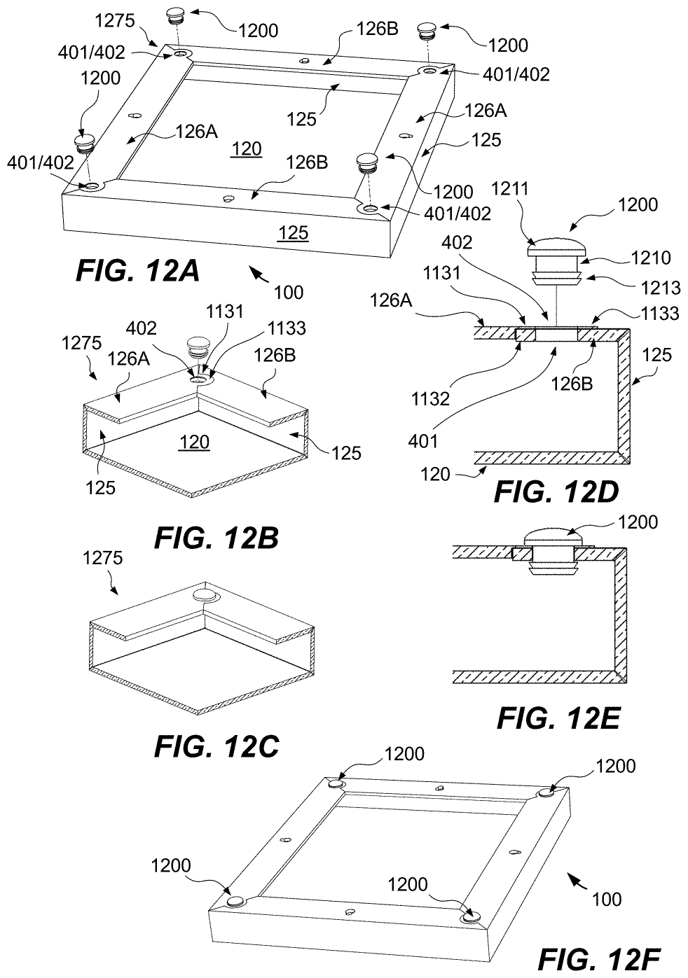

In the example embodiment that FIG. 4 illustrates, the blank 425 comprises four cutouts 405 uniformly spaced about a perimeter 409 of the blank 425. Example channels 430 extend between adjacent cutouts 405. As illustrated, an example array of two parallel channels 430 extends between the adjacent cutouts 405. The channels 430 collectively extend about a central area 426 of the blank 425. As further discussed below with reference to FIGS. 8, 9, and 10, inter alia, corners 110 are formed in the blank 425 along the channels 430 in connection with forming the blank 425 into the housing 100. The illustrated example blank 425 comprises an aperture 401 and an aperture 402 disposed on opposing sides of each cutout 405. As discussed below with reference to FIGS. 11 and 12, the apertures 401 and 402 support providing structure and maintaining the housing 100 in a desired geometry. The blank 425 further comprises hanging apertures 440 disposed midway between each adjacent cutouts 405.

Turning now to FIGS. 5A, 5B, and 5C, these figure illustrate example cross sections of the blank 425 at Section A-A, as indicated on FIG. 4, in two example channel embodiments according to some embodiments of the disclosure. FIG. 5A illustrates a first example channel 430 in cross section, while FIGS. 5B and 5C illustrate a second example channel 430B in cross section. In FIG. 5A and FIGS. 5B and 5C, the blank reference numbers are 425 and 425B respectively in connection with channel distinctions discussed below.

Referring now to FIG. 5A, this figure illustrates an example cross section of the example blank 425 at Section A-A cutting perpendicularly through the example channel 430 according to some embodiments of the disclosure. The view of FIG. 5A thus illustrates an example cross-sectional profile of the example channel 430 perpendicular to the channel 430. The channel 430 is formed in a major surface 575 of the blank 425 that will be interior to the housing 100 (see FIG. 1) once the housing 100 is formed, and thus can be characterized as an interior surface 575. Opposite the interior surface 575, the blank comprises another major surface 550 that will be exterior to the housing 100 once the housing 100 is formed, and thus can be characterized as an exterior surface 550.

As illustrated, the blank 425 has a thickness 515, between the interior surface 575 and the exterior surface 550. In the illustrated example embodiment, the thickness 515 of the blank 425 is 3 millimeters. In some example embodiments, the thickness 515 is in a range of 2 millimeters to 6 millimeters. As illustrated, the channel 430 comprises a bottom 511 that extends lengthwise along the channel 430 and that is disposed a depth 510 from the interior surface 575. Thus, the illustrated depth 510 can be viewed as the full depth of the channel 430. In the illustrated example embodiment, the full depth 510 of the channel 430 is 2.5 millimeters. In some example embodiments, the full depth 510 of the channel 430 is in a range of 65 percent to 95 percent of the thickness 515. As illustrated, the bottom 511 of the channel 430 has a radius of curvature R1. In the illustrated example embodiment, the radius of curvature R1 is 0.5 millimeters. The term “radius of curvature,” as used herein with reference to a surface, generally refers to the radius of a circular arc that describes curvature of a section of the surface. In some example embodiments, the radius of curvature R1 is at least 10 percent of the thickness 515.

As illustrated by FIG. 5A, the channel 430 comprises two example sidewalls 519 that extend on opposing sides of the channel 430 from the bottom 511 of the channel 430 to rims 552 at the interior surface 575 of the blank 425 where the blank 425 is at full thickness 515. In the illustrated example of FIG. 5A, each sidewall 519 comprises an inner surface 512, an outer surface 513, and a radius of curvature R2 that joins the inner surface 512 with the outer surface 513. In the illustrated example embodiment, the radius of curvature R2 is 1.5 millimeters. In some example embodiments, the radius of curvature R2 is greater than 35 percent of the thickness 515. In the example embodiment that FIG. 5A illustrates, the inner surface 512 is flat or planar, and the outer surface 513 is flat or planar. In some example embodiments, each inner surface 512 can be curved. In some example embodiments, each outer surface 513 can be curved.

In the example embodiment of FIG. 5A, the two inner surfaces 512 form an included angle θ1, which is 93 degrees in the illustrated example. In the example embodiment of FIG. 5A, the two outer surfaces 513 form an included angle θ2, which is 164 degrees in the illustrated example. The channel 430 thus comprises a mouth 517 with a 164-degree included angle θ2. The two outer surfaces 513 join with planar surfaces 514 of the exterior surface 575 at the two rims 552 of the channel 430. Each rim 552 comprises a margin between the channel 430 and where the blank 425 has full thickness 515. The rims 552 extend lengthwise on opposite sides of the channel 430. The outer surfaces 513 thus extend inward from the rims 552 towards a centerline 599 of the channel 430, each at an angle θ3 from the planar surfaces 514 of the exterior surface 575. In the illustrated example, the angle θ3 is 8 degrees. In the illustrated example, the channel 430 has a width 551 between the rims 552 of the channel 430 of roughly 13 millimeters. As discussed above, the full channel depth 510 is 2.5 millimeters. Thus, the full channel width 551 is about 5.2 times the full channel depth 510.

In a cross section taken perpendicular to the channel 430 (as illustrated in FIG. 5A), at all points 598 along the sidewalls 519, from the channel bottom 511 to the channel rims 514, the channel 420 has a width 526 and a depth 525. The width 526 at each sidewall point 598 is across the centerline 599 of the channel 430. The depth 525 at each sidewall point 598 is relative to the channel bottom 511. In some example embodiments (such as for the embodiment that FIG. 5A illustrates), for all points 598 along the sidewalls 519, the width 525 is not less than 210 percent of the depth 525.

In some example embodiments (such as for the embodiment that FIG. 5A illustrates), in a cross section taken perpendicular to the channel 430 (as illustrated in FIG. 5A), between the channel bottom 511 and the channel rims 552, the channel 430 maintains an included angle θ1, θ2 that is not less than 92 degrees.

In some example embodiments (such as for the embodiment that FIG. 5A illustrates), in a cross section taken perpendicular to the channel 430 (as illustrated in FIG. 5A), the channel 430 comprises a mouth 517 oriented towards the interior surface 575 and a bottom 511 oriented towards the exterior surface 550, with the mouth 517 and the bottom 511 on a centerline 599 of the channel 430. The bottom 511 can be disposed a depth 510 below the interior surface 575. In some example embodiments, the mouth 517 extends at least 15 percent of the depth 510 while maintaining an included angle θ2 of not less than 145 degrees.

In some example embodiments (such as for the embodiment that FIG. 5A illustrates), in a cross section taken perpendicular to the channel 430 (as illustrated in FIG. 5A), the channel 430 comprises a bottom 511, two rims 552, two inner surfaces 512 extending from the bottom 511 towards the two rims 552, and a mouth 517 extending from the two inner surfaces 512 to the two rims 522. In some example embodiments, the inner surfaces 512 comprise a first included angle θ1, and the mouth 517 comprises a second included angle θ2, wherein the second included angle θ2 is at least 1.5 times the first included angle θ1. Thus, the channel 430 can comprise a mouth 517 that widens relative to the inner portions of the channel 430. In some example embodiments, the widening can occur progressively, gradually, smoothly, incrementally, discretely, abruptly, or in a stepwise manner (among other alternatives).

Referring now to FIGS. 5B and 5C, these figures illustrate a representative cross section of another example blank 425B comprising another example channel 430B. The view provided by FIGS. 5B and 5C corresponds to the view of FIG. 5A. The blank 425B that FIGS. 5B and 5C illustrate corresponds to the blank 425 illustrated by FIG. 5A and comprises an example of an alternative embodiment thereof. As illustrated, the blank 425 and the blank 425B are distinguished by their respective channels 430, 430B. The channel 430B corresponds to the channel 430 discussed above with reference to FIG. 5A, as an example of an alternative channel embodiment.

In FIG. 5C, the cross-sectional view of the channel 430B is overlaid with a shaded isosceles right triangle 581 (a triangle having angles of 45 degrees, 45 degrees, and 90 degrees). The triangle 581 is overlaid in an orientation in which the triangle 581 is bisected by a centerline 599 of the channel 430B, with the centerline 599 perpendicularly intersecting the base 582 of the triangle 581. The triangle 581 thus has an altitude 577 that is collinear with the channel centerline 599. The 90-degree vertex 583 of the triangle 581 is positioned at a bottom 511 of the channel 430B. As further discussed below, the overlaid triangle 581 provides a reference for describing features of the channel 430 and thus can be characterized as a reference isosceles right triangle.

The example channel 430B illustrated by FIGS. 5B and 5C progressively widens from the bottom 511 of the channel 430B to the channel rims 552, where the blank 425B is at its full thickness 515. The channel 430B comprises sidewalls 519 that each curves from the channel bottom 511 to the rims 552. As illustrated by FIG. 5B, each sidewall 519 is convex relative to a reference line 584 drawn from the channel rim 522 to an intersection 585 of the centerline 599 with the channel bottom 511. Each sidewall 519 bulges relative to the reference line 584.

As illustrated by FIG. 5B, the example channel 430B has an included angle θ4 that increases gradually towards the channel's mouth 517. At an arbitrary location 580 of the illustrated cross-sectional profile of the channel 430B, the included angle θ4 of the channel 430B is formed between reference lines 579 drawn tangent to the channel profile at the location 580. In some example embodiments, including the embodiment that FIGS. 5B and 5C illustrate, the channel 430B has an included angle θ4 that is not less than 92 degrees.

As illustrated by FIG. 5C, the reference isosceles right triangle 581 is positioned in the channel 430B as discussed above, and the channel 430B has a width 526 and a depth 525 at the arbitrary location 580. The reference isosceles right triangle 581 is sized so the altitude 577 of the triangle 581 is of height 524 equal to the channel depth 525 at the arbitrary location 580. Thus, the base 582 of the reference isosceles right triangle 581 extends across the centerline 599 of the channel 430B at the arbitrary location 580. As illustrated by FIG. 5C, the reference isosceles right triangle 581 fits in the channel 430B with clearance, as the included angle θ4 exceeds 90 degrees as discussed above.

For any isosceles right triangle 581, the triangle's base 582 has a length 576 that is twice the height 524 of the triangle's altitude 577. At the arbitrary location 580, the channel width 526 is greater than the length 576 of the triangle's base 582. Thus, at the arbitrary location 580, channel width 526 is greater than twice channel depth 525. In some example embodiments, including the embodiment that FIGS. 5B and 5C illustrate, throughout the cross-sectional profile of the channel 430B, the channel 430B has a width 526 and a depth 525, wherein the width 526 is at least 210 percent of the depth 525.

Turning now to FIGS. 6A and 6B, these figures respectively illustrate, in cross section, an example bit 600 for cutting an example channel 430 in the example blank 425 and the bit 600 cutting the channel 430 according to some embodiments of the disclosure. In the illustrated example embodiment, the bit 600 cuts by rotation about its axis 601 and can comprise a router bit. Accordingly, the illustrated bit 600 is compatible with commercially available routers for forming channels 430.

As illustrated by FIG. 6, the bit 600 is dimensioned for cutting the channel 430 that FIG. 5A illustrates as discussed above. FIG. 6B illustrates the bit 600 cutting the channel 430 of FIG. 5A. Thus, the bit 600 is dimensioned to form the channel 430 with the features and dimensions illustrated by FIG. 5A and the foregoing detailed description directed thereto. As the bit 600 cuts the channel 430 as illustrated by FIG. 6B, the bit 600 effectively imparts the channel 430 with features and dimensions of the bit 600. In the illustrated example configuration, the bit 600 has nonlimiting dimensions as follows. The included angle θ1 is 93 degrees. The radius of curvature R1 is 0.5 millimeters. The radius of curvature R2 is 1.5 millimeters. The diameter ϕ1 is 0.69 millimeters. The diameter ϕ2 is 3.73 millimeters. The diameter ϕ3 is 5.38 millimeters. The diameter ϕ4 is 19.90 millimeters. The dimension 601 is 6.51 millimeters. The dimension 602 is 6.50 millimeters. The dimension 603 is 5.42 millimeters. The dimension 604 is 5.02 millimeters. The dimension 605 is 4.00 millimeters. The dimensions of the bit 600 specified in the present paragraph will be referred to below as “the Specified Bit Dimensions.” All dimensions and values in the present paragraph are nonlimiting examples that are among others supported by the present disclosure.

Turning now to FIG. 7, this figure illustrates the blank 425 at Section B-B (as indicated on FIG. 4) example printed with the image 150 according to some embodiments of the disclosure. FIG. 7 thus illustrates an example embodiment of a printed blank 700. The cross section of FIG. 7 cuts through two channels 430 and a hanging aperture 440. As illustrated, the image 150 is printed on the interior surface 575 and extends across the channels 430. So printed, the image 150 continues without interruption within each channel 430 and on both sides of the each channel 430.

In some example embodiments, a computer printer prints the image 150 directly on the blank 425, for example using a commercially available inkjet printer and printing process that utilizes UV-curable ink, as known in the art. Printing directly on the blank 425 can comprise preparing the interior surface 575 of the blank 425 to promote adhesion of ink to the blank 425. If, for example, the blank 425 is coated with a substance that promotes ink adhesion and the ink is printed on top of the applied coating, the printing would be considered a form of direct printing on the blank 425.

In some example embodiments, the blank 425 is supplied with a high-gloss finish prior to printing. Such a high-gloss finish on the exterior surface 550 of the blank 425 can produce reflection or glare that may interfere with viewing of the printed image 150 on the interior surface 575 of the blank. The glare or reflection can be suppressed by printing the exterior surface 550 of the blank 425 with a clear UV-curable ink that has a matt, satin, or semigloss finish. Thus in some embodiments, in addition to the printed image 150 on the interior surface 575 as illustrated by FIG. 7, the printed blank 700 can comprise a glare-suppression printing on the exterior surface 550.

Turning now to FIG. 8, this figure illustrates example forming of example corners 110 in the printed blank 700 according to some embodiments of the disclosure. As discussed below, the forming can comprise cold working. The term “cold working,” as used herein, generally refers to working a material while the material is either at ambient temperature or at a temperature in a range of 15 degrees Celsius to 30 degrees Celsius. As those of skill in the art will appreciate, cold working may produce localized temperature increases above ambient due to material deformation as the material is worked. The term “ambient temperature,” as used herein, generally refers to a temperature of a surrounding medium, for instance air temperature in a workroom where a material is being worked. An approximate thermostat setting could, for instance, control air temperature of a workroom.

To form the corners 110, forces 800 are applied to the printed blank 700 to bend or fold the printed blank 700 at the channels 430, so that the channels 430 close. The printed blank 700 thus hinges along each channel 430. In some example embodiments, the corners 110 can be formed by hand with the printed blank 700 at ambient temperature. Human hands may manually apply the forces 800 without needing to heat the printed blank 700 substantially above ambient temperature for the purpose of shifting temperature-dependent mechanical properties of the blank 700. Thus, the corners 110 can be formed without necessarily elevating the temperature of the printed blank 700 above room temperature in preparation for forming or without heating to a temperature that may adversely affect the printed image 150. For instance, the corners 110 can be formed in the printed blank 700 with the printed blank 700 at a temperature in a range of 10 to 40 degrees Celsius. In some example embodiments, the printed blank 700 can be warmed in preparation for the forming the corners 110, for example by moving the blank 700 from a cold warehouse to a warm room, a warm area of a room, or a warm storage bin or by using a hairdryer to warm the printed blank 700.

In some example embodiments, the printed blank 700 has been printed with an ink that degrades above a threshold temperature or that has a maximum temperature rating. In some such embodiments, the printed blank 700 can be warmed to a temperature that is at or below the threshold temperature or that is at or below the maximum temperature rating.

As discussed above, the example channels 430 have a smallest included angle θ1 (see FIG. 5A) of 93 degrees. Thus, the printed blank 700 can be bent to an included angle θ5 that is acute or less than 90 degrees before the two inner surfaces 512 of the sidewalls 511 of the channel 430 (see FIG. 5A) butt against one another. In an example embodiment, with the included angle θ1 of the channel 430 at 93 degrees, the printed blank 700 can be bent to an included angle θ5 of at least about 87 degrees without substantial sidewall interference. Bending more acutely than 90 degrees helps compensate for a tendency of the corners 110 to spring back or open up when the bending forces 800 are released and the printed blank 700 relaxes.

Turning now to FIG. 9, this figure illustrates example corners 110 formed in the blank 425 and the printed image 150 according to some embodiments of the disclosure. In the configuration of FIG. 9, the printed blank 700 has been released from the bending forces 800 that FIG. 8 illustrates. In this relaxed state, as illustrated, the included angles θ6 of the corners 110 are 90 degrees, which is the desired endpoint in the illustrated embodiment, thereby forming front and rear corners for the housing 100.

Turning now to FIG. 10, this figure illustrates a detail cross-sectional illustration of an example corner 110 in the printed blank 700 according to some embodiments of the disclosure. FIG. 10 more specifically illustrates a detail view of a portion 900 of the printed blank 700 as formed and illustrated in FIG. 9. The printed image 150 at the corner 110 can be presented with fidelity to an viewer looking through the exterior surface 550 towards the interior surface 575, upon which the image 150 is printed. As illustrated, the corner 110 has an included angle θ6 of 90 degrees adjacent the channel 430. As a result of the channel 430 being originally formed with an included angle θ1 of 93 degrees (as discussed above with reference to FIG. 5A, inter alia) and the corner 110 being formed with the included angle θ6 of 90 degrees, the channel 430 retains an opening 1000. In some example embodiments, the opening 1000 extends at least 50 percent of the full depth 510 of the channel 430 as originally formed in the blank 425 as discussed above with reference to FIG. 5A. In some example embodiments, the opening 1000 has a width of at least 0.3 millimeters.

This paragraph discusses experimental testing that was conducted. A blank corresponding to the blank 425 illustrated by FIG. 4 was produced. The produced blank was composed of clear PETG. The produced blank comprised channels configured with the cross-sectional geometry that FIG. 5A illustrates. The channels of the produced blank were formed according to the following specifications: thickness 515 of the blank 425: 3 millimeters; full depth 510 of the channel 430: 2.5 millimeters; radius of curvature R1: 0.5 millimeters; radius of curvature R2: 1.5 millimeters; included angle θ1: 93 degrees; included angle θ2: 164 degrees; and angle θ3: 8 degrees. The channels of the produced blank were formed using a bit that was configured with the geometry that FIG. 6A illustrates and that was made according to the Specified Bit Dimensions. The formed channels were not measured to determine deviation from the specifications due to fabrication error. A printed blank was formed by printing a color image on the formed blank with the color image extending across the channels. The printed color image continued without interruption within each channel and on both sides of the each channel. Corners were formed in the printed blank adjacent the channels by cold working the printed blank. An adult male human completed the cold working manually, by manipulating the printed blank with his two hands. FIGS. 7, 8, and 9 describe how the corners were cold worked. There were no observations of damage to the printed color image from the cold working of the corners. The printed color image was observed to exhibit relatively high fidelity at the corner. As discussed above with reference to FIGS. 1, 2, and 3, FIG. 1 generally reflects the resulting fidelity at the corner, using a different image than the color image printed in these experimental tests. This sentence concludes the discussion in the present paragraph of experimental testing.

Turning now to FIGS. 11A, 11B, 11C, 11D, and 11E, FIGS. 11A, 11B, 11C, and 11D illustrate progressively forming the printed blank 700 into an example three-dimensional housing 100 that houses the printed image 150 according to some embodiments of the disclosure. As the printed blank 700 is folded to form the housing 100, the apertures 401 respectively align with the apertures 402.

FIG. 11E illustrates a detail view of a portion 1150 of the printed blank 700 that comprises a cutout 405. A projecting edge 1132 of the printed blank 700 is disposed on one side of the cutout 405, and the aperture 401 extends through the projecting edge 1132. A recessed edge 1131 of the printed blank 700 is disposed on the opposing side of the cutout 405, and the aperture 402 extends through the recessed edge 1131. The recessed edge 1131 comprises a receptacle that receives the projecting edge 1132 for alignment of the apertures 401, 402. As illustrated, the projecting edge 1132 seats in and mates with the recessed edge 1131.

As illustrated by FIG. 11E, the recessed edge 1131 is recessed into the interior surface 575 of the printed blank 700. As illustrated by FIG. 5A and as discussed above, the channels 430 are also formed in the interior surface 575. Accordingly, the recessed edges 1131 and the channels 430 can be cut into a single side the blank 425 (see FIG. 5A), without having to flip the blank 425 to work both sides of the blank 425 during fabrication.

Turning now to FIGS. 12A, 12B, 12C, 12D, 12E, and 12F, these figures illustrate securing the housing 100 in a three-dimensional structure using example hybrid fastener-bumper members 1200 according to some embodiments of the disclosure. The term “hybrid fastener-bumper member,” as used herein, generally refers to a member that comprises a fastener and a bumper.

FIGS. 12A, 12B, and 12D illustrate the hybrid fastener-bumper members 1200 oriented for insertion in the respectively aligned apertures 401, 402 to secure the housing 100 in the three-dimensional form illustrated by FIGS. 11D, 12A, and 12F. FIGS. 12C, 12E, and 12F illustrate the hybrid fastener-bumpers members 1200 inserted in the respectively aligned apertures 401, 402, thereby securing a rigid, three-dimensional structure. FIGS. 12B and 12C illustrate three-dimensional sectional views of a portion 1275 of the housing 100. FIGS. 12B and 12C illustrate cross-sectional views that cut through two aligned apertures 401, 402 of the housing 100. As illustrated, the housing 100 comprises a front pane 120, four side panes 125 that extend rearward from the front pane 120, and four rear panes 126A, 126B that respectively extend from the four side panes 125 behind and substantially parallel to the front pane 120.

As best seen in FIGS. 12B and 12D, the recessed edge 1131 comprises a receptacle in the rear pane 126A that receives the projecting edge 1132 of the rear pane 126B in which the aperture 401 is disposed. When the apertures 401, 402 are aligned, the projecting edge 1132 of the rear pane 126B seats in and mates with the recessed edge 1131, and an exterior portion 1133 of the recessed edge 1131 overlaps the projecting edge 1132.

In the illustrated example embodiment of FIG. 12, as best seen in the cross-sectional view of FIGS. 12D, each hybrid fastener-bumper member 1200 comprises a shaft 1210, a head 1211 disposed at one end of the shaft 1210, and barbs 1213 disposed adjacent an opposite end of the shaft 1210. In the illustrated example, the barbs 1213 comprise projections that circumscribe the shaft 1210 and extend radially from the shaft 1210. As illustrated, the projections can be triangular or angled relative to the shaft 1210. The head 1211 is diametrically oversized relative to the apertures 401, 402. The shaft 1210 is diametrically sized for insertion in the apertures 401, 402. The barbs 1213 are diametrically sized for passing through the apertures 401, 402 under elastic deformation.

In the illustrated example, the hybrid fastener-bumper members 1200 comprise an elastomer or an elastomeric material, for example silicone or synthetic rubber. The resulting elastic properties can facilitate insertion of the hybrid fastener-bumper members 1200 into the aligned apertures 401, 402 as illustrated. The barbs 1213 in combination with the elastic properties facilitate retention of the hybrid fastener-bumper members 1200 in the aligned apertures 401, 402, thereby fastening adjacent rear panes 126A, 126B to one another. Once the hybrid fastener-bumper members 1200 are inserted in the aligned apertures 401, 402, the heads 1211 project rearward from the housing 100 as illustrated by FIGS. 12E and 12F. The elastic properties of the heads 1211 provide bumpers for protecting the housing 100 from shock, for instance absorbing impact associated with mounting the housing 100 to a vertical surface.

In some example embodiments, the hybrid fastener-bumper members 1200 are composed of PET or PETG, or another appropriate polymer, to facilitate recycling of the housing. For example, the hybrid fastener-bumper members 1200 and the printed blank 700 can have a common composition of PETG.

Turning now to FIG. 13, this figure illustrates an example flow chart of an example process 1300 for housing an image 150 according to some embodiments of the disclosure.

At block 1320 of example process 1300, the channels 430 and recessed edges 1131 are formed in an interior surface 575 of a blank 425. The foregoing discussion and the accompanying Figures disclose details for practicing example embodiments of block 1320.

At block 1340, the image 150 is printed on the interior surface 575, including in the formed channels 430, to produce a printed blank 700. The foregoing discussion and the accompanying Figures disclose details for practicing example embodiments of block 1340.

At block 1360, the printed blank 700 is cold worked along the channels 430 to form a housing 100. The foregoing discussion and the accompanying Figures disclose details for practicing example embodiments of block 1360.

At block 1380, hybrid fastener-bumper members structurally secure the housing 100. The foregoing discussion and the accompanying Figures disclose details for practicing example embodiments of block 1380.

Example process 1300 ends following execution of blocks 1320, 1340, 1360, and 1380.

Useful technology for housing images has been described. From the description, it will be appreciated that an embodiment of the disclosure overcomes limitations of the prior art. Those skilled in the art will appreciate that the technology is not limited to any specifically discussed application or implementation and that the embodiments described herein are illustrative and not restrictive. Furthermore, the particular features, structures, or characteristics that are set forth may be combined in any suitable manner in one or more embodiments based on this disclosure and ordinary skill. Those of ordinary skill having benefit of this disclosure can make, use, and practice a wide range of embodiments via combining the disclosed features and elements in many permutations without undue experimentation and further by combining the disclosed features and elements with what is well known in the art. This disclosure not only includes the illustrated and described embodiments, but also provides a rich and detailed roadmap for creating many additional embodiments using the various disclosed technologies, elements, features, their equivalents, and what is well known in the art. From the description of the example embodiments, equivalents of the elements shown herein will suggest themselves to those skilled in the art, and ways of constructing other embodiments will appear to practitioners of the art. Therefore, the scope of the technology is to be limited only by the appended claims.

What is claimed is:

1. An apparatus comprising
a blank that comprises:
a sheet comprising:
a first major surface and a second major surface that oppose one another; and
a thickness of clear PETG disposed between the first and second major surfaces;
a perimeter extending around the sheet; and
a plurality of cutouts in the perimeter that are uniformly spaced about the perimeter; and
a plurality of arrays of channels formed in the first major surface, wherein the plurality of arrays of channels and the plurality of cutouts correspond in number, and wherein each array of channels respectively extends fully between two adjacent cutouts in the plurality of cutouts,
wherein each channel in each of the arrays comprises:
a depth that is in a range of 65 percent to 95 percent of the thickness;
a width that is no less that 210 percent of the depth;
a bottom that is disposed at the depth, that extends lengthwise, and that is curved when viewed in a cross section taken perpendicular to the channel.

2. The apparatus of claim 1, wherein the thickness is in a range of 2 millimeters to 6 millimeters.

3. The apparatus of claim 2, wherein the bottom is curved with a radius of curvature that is greater than 10 percent of the thickness.

4. The apparatus of claim 2, wherein each channel further comprises:
a first rim and a second rim that extend lengthwise on opposing sides of the channel; and
a first sidewall and a second sidewall extending respectively from the first rim and the second rim towards the bottom,
wherein the first sidewall and the second sidewall respectively comprise a first sidewall portion disposed adjacent the first rim and a second sidewall portion disposed adjacent the second rim, and
wherein each of the first sidewall portion and the second sidewall portion is curved when viewed in a cross section taken perpendicular to the channel.

5. The apparatus of claim 4, wherein the first sidewall portion is curved with a radius of curvature that is greater than 30 percent of the thickness, and wherein the second sidewall portion is curved with a radius of curvature that is greater than 30 percent of the thickness.

6. The apparatus of claim 4 further comprising an image printed on the first major surface and extending contiguously across at least one of the channels,
wherein a first portion of the printed image is printed outside said at least one of the channels on a first side of said at least one of the channels,
wherein a second portion of the printed image is printed outside said at least one of the channels on a second side of said at least one of the channels, opposite the first portion of the printed image, and
wherein a third portion of the printed image is printed in said at least one of the channels and extends from the first rim of said at least one of the channels to the second rim of said at least one of the channels.

7. The apparatus of claim 2, where each cutout comprises:
a projecting edge disposed on a first side of said each cutout; and
a recessed edge disposed on a second side of said cutout that opposes the first side of said each cutout, wherein the recessed edge is recessed into the first major surface, and wherein the recessed edge and the projecting edge are sized to mate with one another.

8. The apparatus of claim 2, wherein each cutout comprises:
a first aperture extending from the first major surface to the second major surface on a first side of said each cutout; and
a second aperture extending from the first major surface to the second major surface on a second side of said cutout that opposes the first side of said each cutout, and
wherein the apparatus further comprises a member that is composed of an elastomer and that is sized for insertion in said first and second apertures when elastically deformed.

9. The apparatus of claim 8, wherein said member comprises a hybrid fastener-bumper member.

10. An apparatus comprising:
a sheet of malleable material formed into a housing that comprises:
a front pane;
a plurality of side panes, each side pane extending rearward from the front pane at a respective first angle relative to the front pane, each side pane forming a respective front corner with the front pane; and
a plurality of rear panes, each rear pane extending behind the front pane from a respective side pane at a respective second angle relative to the respective side pane, each rear pane forming a respective rear corner with the respective side pane,
wherein the plurality of rear panes comprises:
a first rear pane that comprises a first portion that comprises a first aperture extending through the sheet of malleable material; and
a second rear pane that comprises a second portion that comprises a second aperture extending through the sheet of malleable material,
wherein the first rear pane is disposed adjacent the second rear pane, wherein the first portion overlaps the second portion, and wherein the first aperture is aligned with the second aperture; and
a member that comprises a polymer, that extends through the first aperture and the second aperture, and that fastens the first rear pane and the second rear pane to one another, wherein the member comprises a projection that projects rearward from the housing and that comprises a bumper.

11. The apparatus of claim 10, wherein the malleable material comprises clear PETG,
wherein the polymer comprises an elastomer, and
wherein the sheet has a thickness in a range of 2 millimeters to 6 millimeters.

12. The apparatus of claim 11, wherein the housing further comprises:
an interior surface and an exterior surface,
a plurality of channels formed in the interior surface and respectively extending along said respective rear corners and said respective front corners.

13. The apparatus of claim 12, wherein each of said channels comprises a respective opening with a width of at least 0.3 mm.

14. The apparatus of claim 13, further comprising an image that is attached to the interior surface and extends into said respective opening.

15. The apparatus of claim 12, wherein the plurality of channels comprises a subplurality of channels respectively extending along said respective front corners, and
wherein the apparatus further comprises an image printed on said interior surface and extending contiguously across the subplurality of channels.

16. The apparatus of claim 10, wherein the first portion comprises a recessed edge, and wherein the second portion is seated in a recess of the recessed edge,
wherein the malleable material comprises PETG, and
wherein the polymer comprises PETG.

17. A method comprising:
providing a sheet of clear PETG with a thickness in a range of 2 millimeters to 6 millimeters, the sheet comprising at least four cutouts that are peripherally disposed, wherein channels respectively extend between adjacent cutouts in said at least four cutouts;
printing an image on the sheet, wherein the image extends into the channels; and
cold working the sheet to form respective corners that extend lengthwise adjacent the channels.

18. The method of claim 17, wherein each channel has a depth and a width that is at least 210 percent of the depth.

19. The method of claim 18, wherein each channel comprises a bottom disposed at the depth and sidewalls that extend laterally from the bottom to a major surface of the sheet,
wherein printing said image comprises printing on said bottoms and on said sidewalls.

20. The method of claim 19, further comprising:
aligning a first aperture that is disposed in a first portion of the sheet with a second aperture that is disposed in a second portion of the sheet; and
maintaining alignment of the first aperture with the second aperture by inserting a fastener through the first aperture and the second aperture, wherein the fastener comprises a bumper,
wherein cold working the sheet comprises bending the sheet with the sheet substantially at ambient temperature.
